(19) United States
(12) Patent Application Publication
(10) Pub. No.: US 2024/0320614 A1
(43) Pub. Date: Sep. 26, 2024

(54) SYSTEM, PLATFORM, AND METHODS FOR NEURAL NETWORK ENABLED BLOCKCHAIN-BASED MANUFACTURING WORKFLOW

(71) Applicant: SYNCFAB CO., Sheridan, WY (US)

(72) Inventor: Jeremiah Goodwin, Santa Monica, CA (US)

(21) Appl. No.: 18/125,720

(22) Filed: Mar. 23, 2023

(51) Int. Cl. G06Q 10/087; G06N 3/0895

(52) U.S. Cl. CPC G06Q 10/087; G06N 3/0895

(57) ABSTRACT

A system, platform, and methods for incentivizing adequacy communication between buyers and suppliers, track supply chain events via electromagnetic signature detection and sensor feedback, secure recordation of supply chain events via blockchain technology, and determine and diagnose supply chain failures using neural networks.

### PRIORITY CLAIM

This U.S. Non-provisional application claims the benefit of and priority to U.S. non-provisional application Ser. No. 16/731,840, filed Dec. 31, 2019, which in turn claims the benefit and priority to U.S. provisional application No. 62/917,788, filed Dec. 31, 2018. The above referenced applications are fully incorporated herein as if restated in their entirety.

### SUMMARY

The system may comprise a platform and a set of methods actuated via the platform. The system and platform may be embodied by and the methods may be actuated across a set of computers operating over a network. The platform may comprise separate buyer and supplier portals, with the buyer and supplier portals distinguished based on interface features and system access, or the platform may comprise an omnibus interface in which users may access buyer or supplier features freely. The platform may comprise an account architecture, with each account being associated with a set of sub-accounts, internal and external financial (banking and transaction) accounts, user profiles, account profiles, marketing profiles, and external pages. The financial accounts may include cryptocurrency wallets, particularly wallets dedicated to a cryptocurrency native to the platform.

The system may comprise a database for storing information pertaining to users, accounts, and interactions (transactions) between users/accounts. The database may be conventional or blockchain-based. In one embodiment, the system comprises a plurality of blockchains, with each blockchain dedicated to a given dataset. In one embodiment, the blockchains are inter-connected, with reference information stored on a first blockchain connected to expansive information on a second blockchain. In another embodiment, the blockchains comprise various levels of public access, with some sub-set of blockchains inaccessible or otherwise unreadable to the public except via encryption keys or sufficient login credentials. In one embodiment, a sub-set of blockchains are coupled to cryptocurrencies, including the cryptocurrency native to the system and platform.

The system may comprise a set of neural networks, with sub-sets of neural networks interlinked via transitioning outputs into inputs, with some sub-sets of neural networks interlinked in a circular manner, such that each neural network receives as input the output of some other neural network in the sub-set. The neural networks may be interoperable with so-called expert systems or other artificial intelligent systems that do no comprise neural networks. The neural networks may be each dedicated to handling a given type of dataset, including visual data such as images and video, audio data such as video and oral communications, text data such as email communications, or combinations thereof, such as drawings, blueprints, computer-generated graphical data, and invoices. A sub-set of neural networks may be dedicated to scanning, detecting, or otherwise receiving, and processing user account information.

The system may comprise a set of input devices, including mouse, trackpad, touchscreen, keyboard, microphone, camera, etc. The system may also include dedicated input devices, such as RFID tracker or other trackers/readers of digital signatures embedded in an electromagnetic field (EM readers). The system may also encompass sensors for any relevant parameter, such as weight sensors, optical sensors, turbidity sensors, pressure sensors, chemical sensors, etc.

In one embodiment, exemplary system architecture may include an EM reader configured to communicate wirelessly with a first set of processors, the first set of processors configured to update one or more databases based on the EM data captured by the EM reader, as well as the time and location of the capture. The EM data captured may be an identity of a new or previously detected supply-chain part, unit, material, or product. A camera may be configured to capture image data corresponding to the part, unit, material, or product, and transmit the image data to a second set of processors, with the second set of processors configured to update one or more databases based on the image data captured by the camera, as well as the time and location of the capture. A text input device may be configured to receive from a user text data pertaining to the part, unit, material, or product and transmit the text data to a third set of processors, with the third set of processors configured to update one or more databases based on the text data received by the text input device, as well as the time and location of the receipt. Other sensors may be similarly configured for detecting part, unit, material, or product parameters and transmit those parameters to a fourth set of processors, which in turn are similarly configured to update databases. The various sensors, EM reader, camera, and text input device may each require or be capable of determining a given user responsible for handling or otherwise operating them at the time of the data capture/receipt. These devices may be coupled to GPS or other location detecting components, as well as time detection components such as digital timekeeping applications. The devices may have fingerprint detection modules for determining a user account associated with the user via fingerprint detection. The devices may have login credential requirements for use or the authentication thereof. The devices may have calibration requirements, with caveat data transmitted if the calibration periods have elapsed.

In one embodiment, the exemplary system may associate the various sensor feedback data, EM data, image data, and text data to correspond to a single part, unit, material, or product entry. In one embodiment, the exemplary system may compare the status of the entry with a pre-determined or formulated schedule to determine if the part, unit, material, or product has satisfied a pre-determined status milestone. In one embodiment, the exemplary system may determine whether a given feature, as detected or otherwise determined via the EM, image, or text data matches a blueprint, specification, or other pre-determined quality requirement. Status milestones may correspond to the level of completion of a part, unit, material, or product. Quality requirements may correspond to endurance, efficacy, appearance, or any other desirable quality separate from the mere completion status.

The satisfaction of one or more status milestones and/or quality requirements may be detected by a milestone and requirements module, and thereafter a satisfaction protocol may be actuated via a transaction actuation module. A satisfaction protocol may include a script comprising various commands or instructions, with these commands or instructions previously encoded in the system, agreed to by users of the platform, or agreed to specifically between two separate users of the platform and parties to a given transaction. The commands and instructions with their associated predicates may be embedded in a platform contract, including a native crypto-currency contract. The commands and instructions may include the transmission of payment from one internal or external account to another, or the imposition of a penalty on an internal or external account. Predicates of the commands and instructions may be any status milestone or quality requirement.

As discussed previously, neural networks may be invoked in the processing of the sensor, EM, image, and text data to determine whether the quality requirement or status milestone has been reached. Inputs to these neural networks may include forms, invoices, written contracts, and/or recordings of spoken agreements. Additional inputs may include industry standards and/or government regulations, as embedded, encoded, or otherwise present in standardized forms or websites.

In one embodiment, an exemplary system may be configured to receive, via the platform, communications between users, particularly buyers and suppliers. These communications may include various questions and requests, and the sharing of drawings or other documents. The system may be configured to determine, via a communication adequacy module, whether communications transmitted by a first user to a second user are adequately answered or addressed by the second user. Adequacy here may be determined via so-called expert systems, in which entry fields of a previously established or newly submitted form are determined to be populated or non-populated, or via neural networks, which receive both sets of communications and, based on previous training together with continued training via buyer feedback, rate the response communications. If communications are determined inadequate, the platform may share the determination of inadequacy with the supplier.

Adequacy may be based on the size or length of the response communication, the timeliness of the communication, the completeness of the communication, and/or the time spent by the supplier in creating the response communication. In this manner, robust response communications may be deemed more adequate that superficial response communications, fast communications may be deemed more adequate than slow communications, complete communications may be deemed more adequate than incomplete communications, etc.

In one embodiment, the system ranks and the platform displays the ranking of suppliers based on their communication adequacy. In one embodiment, adequacy data is saved to one or more databases, including a blockchain-based database. In this embodiment, native crypto-currency may be programmed to determine adequacy events, (i.e., a determination of a present or history of adequate communication) and transfer cryptocurrencies or other financial incentives to internal or external financial accounts belonging to the supplier determined to possess the adequate communication. In this manner, suppliers are rewarded for adequate communication regardless of whether buyers move forward with transactions or not.

In one embodiment, an exemplary system may comprise one or more transaction potential neural networks. Transaction potential neural networks may be configured to detect, based on processing internal and external financial accounts and buyer payment history as stored in transaction databases, whether buyers are able and likely to adequately pay for transactions involving suppliers. The transactions involving the suppliers are detected by processing the communications between the buyers and suppliers. If the system determines that the buyer is requesting information pertaining to a transaction for which the buyer is unable to or unlikely to adequately pay, the system may transmit a warning to the buyer and/or the supplier; this enables the supplier to be on notice that the presently discussed transaction is at best hypothetical, which therefore enables suppliers to pay more attention to transactions which are likely to occur, thereby increasing the efficiency of the system. Similarly, the transaction potential neural networks may be configured to determine whether a supplier is likely to adequately supply the parts, units, materials, and products in a transaction based on an analysis of the machinery and labor available to the supplier. This analysis may utilize image data of the supplier location or entries in the supplier account page, as well as the history of past transactions between the supplier and other buyers.

Additionally, the transaction potential neural network may determine whether the supplier has adequate relationships with other suppliers in order to ensure that the supplier can quickly obtain the materials or parts necessary to supply the parts, units, or products required by the transaction. The possession of such relationships may be determined by processing past communications and transactions between the supplier and other suppliers.

If the transaction potential neural network determines that the requests for production communication from the buyer to the supplier are unlikely to be met by the supplier, then the system will alert the buyer of this fact, enabling the buyer to direct procurement efforts toward other suppliers. Here, supply adequacy entails the meeting of quality requirements as well as status milestones.

In another embodiment, transaction potential neural networks determine supply adequacy not merely for actual communications between buyers and a given supplier, but also for that supplier based on communications between buyers and other suppliers; this way, the supplier will be informed whether their machines and labor are sufficient to handle such hypothetical transactions. The transaction potential neural network may be configured to inform the supplier what areas the supplier needs to improve in order to accept such transactions. For example, the transaction potential neural network may advise on an increase in labor force and/or machines. As another example, the transaction potential neural network may advise on the establishment of relationships with up-stream suppliers. This transaction potential neural network behavior encourages advancement of the entire ecosystem by increasing the competency and skill-set of suppliers across channels desirable to buyers.

In one embodiment, an exemplary system may comprise one or more supervisory neural networks. Supervisory neural networks may be configured to receive as input the output of other neural networks and/or expert systems, or to process data that is not otherwise processed by other artificial intelligent systems. The purpose of the supervisory neural networks is to determine points of conflict, delay, failures to meet expectations, and other problems and inefficiencies in the supply chain. Supervisory neural networks are designed to examine the ecosystem as a whole, but may also be used to assist individual users or facilitate individual transactions.

The supervisory neural networks may include natural language processing to process buyer and/or supplier feedback. The supervisory neural networks may be configured to detect patterns of adequacy or inadequacy in communications between buyers and/or suppliers. The supervisory neural networks may be configured to detect patterns in failures to reach status milestones or failures to meet quality requirements for parts, units, materials, or products.

The data processed by the supervisory neural networks may include timestamps to assist in pattern recognition. For example, if the supervisory neural networks determine that there is a relationship between the communications between a first supplier and other suppliers, and that the materials or parts supplied by the other suppliers to the first supplier are incorporated into parts, units, or products which have failed to reach status milestones, then the supervisory neural network may determine that the failure to reach status milestones was due to procrastination in communicating with the up-stream suppliers, and subsequently inform the supplier to initiate communications sooner during production for future transactions.

The supervisory neural networks may track the frequency and reasons behind status milestone and quality requirement failures, summarize these facts graphically, and report them to administrators of the platform. Such reports may be distributed by a platform communication module to all buyers and suppliers so remind buyers and suppliers of best practices, inform them as to deficiencies in their peers, and advise them to avoid making similar mistakes. In this manner, the efficiency of the ecosystem as a whole is improved.

In one embodiment, an exemplary system may comprise machine and labor tracking methods to determine when machines are being overused or in need of repair, or whether labor is being overworked and therefore at risk of injuries or mistakes. The tracking methods may include processing labor timesheets, image data revealing the number of hours a given labor unit works, whether the labor unit wears adequate protective gear, etc. The tracking methods may also include tracking the electrical use of machines as heuristics for use via current sensors, the duration of use of the machines, and the frequency of maintenance checks and repair. The frequency of maintenance checks and repairs may be captured by the scanning of EM signatures of machines or machine parts by maintenance workers. Use of machines and labor may also be inferred by the details and transactions undertaken by the suppliers. The captured data described here, along with actual reports of injuries or machine malfunctions, may be processed by machine and labor tracking neural networks, which may be utilized to predict injures and malfunctions based on streaming data.

### BRIEF DESCRIPTION OF THE DRAWINGS

FIG. 1 shows an exemplary system architecture.

FIG. 2 shows an exemplary system process.

### DETAILED DESCRIPTION OF THE DRAWINGS

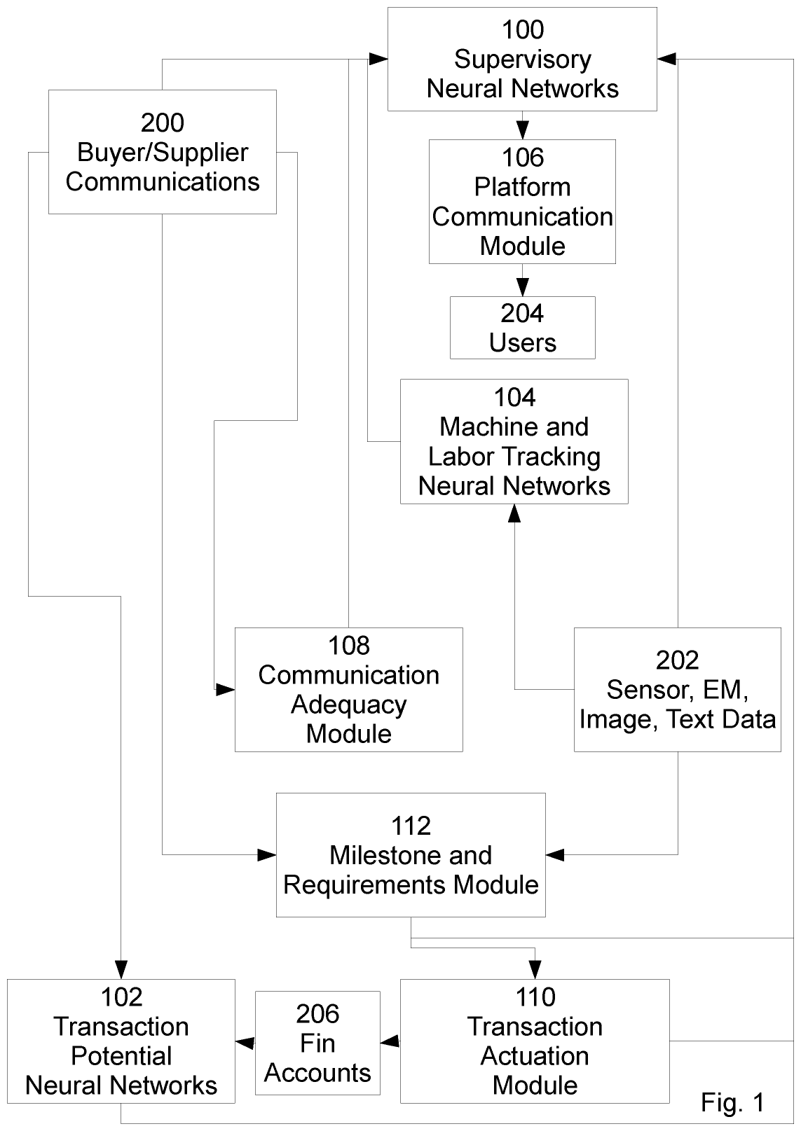

As shown in FIG. 1, the supervisory neural networks 100 are trained on data received from transaction actuation module 110, the milestone and requirements module 112, the buyer/supplier communications 200, the machine and labor tracking neural networks 104, the sensor, EM, image, and text data 202, the transaction potential neural networks, and the communication adequacy module 108. This data may be initially labeled by administrators, but continued input of these data streams enables self-supervised training. The supervisory neural networks produce graphical reports which are transmitted to the platform communication module 106, which then transmit advise, suggestions, and warnings to users, including buyers, suppliers, and administrative users.

Buyer/Supplier communications 200, sensor, EM, image, and text data 202 are used by the milestone and requirements module 112 to determine what status milestones and quality requirements were implicit or explicit in a transaction agreement between a buyer and a supplier, and what status milestones and quality requirements have been met. The satisfaction of these milestones and requirements, or lack thereof, is transmitted to the transaction actuation module 110, which processes payment from the buyer to the supplier, or imposes penalties on the supplier. Such processing and impositioning is applied to user financial accounts 206.

The buyer/supplier communications 200 are also processed by the communication adequacy module 108, which determines whether supplier responses to buyer queries are adequate. Adequacy may be incentivized by the processing of payments and impositioning of penalties to suer financial accounts (not shown).

The machine and labor tracking neural networks 104 may receive sensor, EM, image, and text data 202 from a supplier location to predict when machines need to be maintained or labor needs to be trained for safety compliance.

The transaction potential neural networks 102 may determine, based on buyer/supplier communications 200, buyer financial accounts 206, and sensor, EM, image, and text data whether buyers are capable of paying for a given transaction and whether suppliers are capable of meeting milestones and quality requirements for the given transaction.

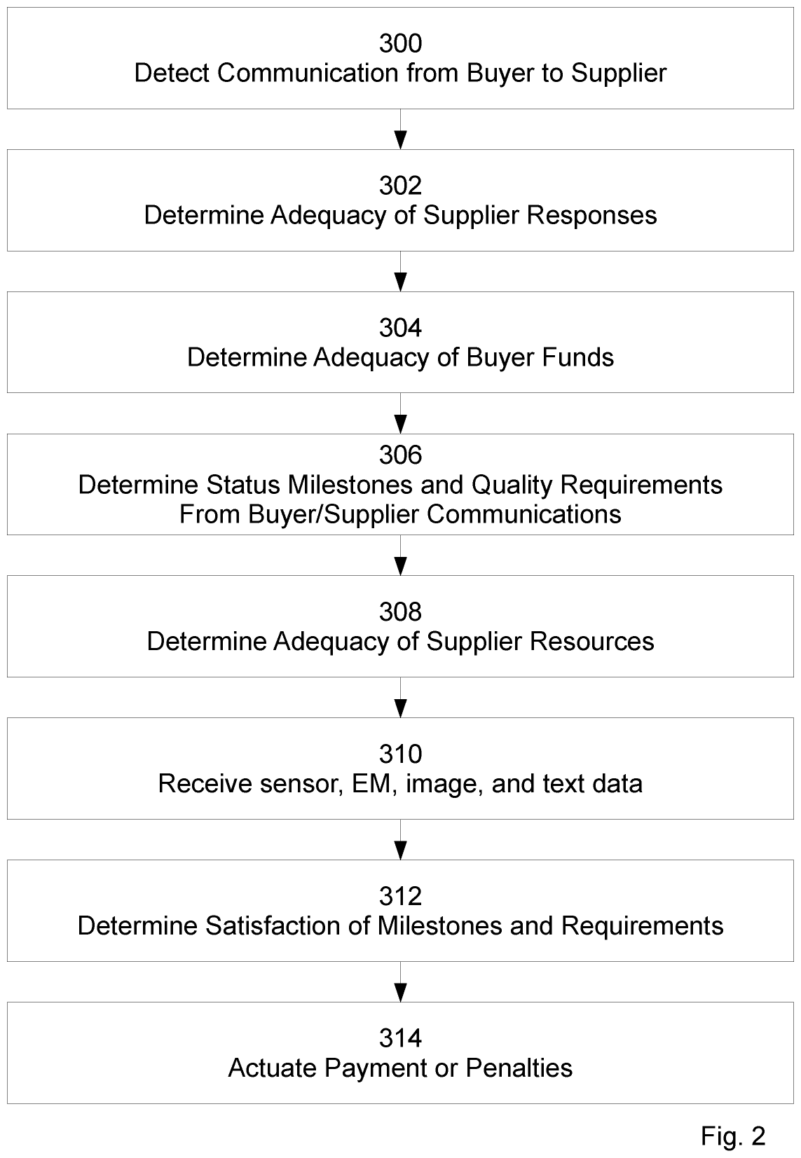

As shown in FIG. 2, the system processors may be programmed to detect communications on the platform between a buyer and a supplier 300. The communication adequacy module may be then determine whether the supplier responses were adequate 302. The milestone and requirements module may determine the milestones and requirements of the pending transaction 306 by processing the communications. The transaction potential neural networks may determine whether the supplier is able to satisfy the milestones and requirements 308. The milestone and requirements module may receive various data pertaining to production 310, such as sensor data, electromagnetic signatures corresponding to parts, units, materials, or products, image data depicting features of the same, and text data describing the same, and then determine whether the milestones and requirements are met 312. If they are met, then the transaction module may actuate payment; if not, it may impose penalties on the supplier 314.

1. A system comprising a platform, a set of computers connected over a network, a set of databases, and a set of input devices;
a. the set of input devices comprising sensors, cameras, keyboards, and EM readers;
b. the platform comprising buyer portals and supplier portals and configured to be accessed by buyer users, supplier users, and administrative users;
c. the set of databases including blockchains;
i. the blockchains comprising a first blockchain and a second blockchain;
ii. with the first blockchain comprising referent data and the second blockchain comprising expansive data;
iii. with the referent data corresponding to the expansive data;
iv. with the referent data being accessible and readable by a public;
v. with the expansive data being accessible and readable only to a subset of buyer, supplier, and administrative users;
d. the set of computers configured to run a set of modules comprising neural networks and expert systems to enable platform functionality;
i. the set of neural networks and expert systems including:
1. supervisory neural networks;
2. machine and labor tracking neural networks;
3. milestone and requirements module;
4. a communication adequacy module;
5. a platform communication module;
6. transaction potential neural networks;
7. a transaction actuation module;
e. with the supervisory neural networks configured to receive output data from the machine and labor tracking neural networks, the communication adequacy module, the milestone and requirements module, the transaction potential neural networks, and the transaction actuation module;
f. with the supervisory neural networks configured to provide graphical reporting data to the platform communication module;
g. with the platform communication module configured to distribute the graphical reporting data to the buyer users, supplier users, and administrative users;
h. with the machine and labor tracking neural networks, transaction potential neural networks, supervisory neural networks, and milestone and requirements module configured to receive data from the sensors, keyboards, cameras, and EM readers;
i. with the milestone and requirements module configured to determine milestones and requirements for a given transaction by processing buyer and supplier communications and determine whether the milestones and requirements are satisfied via the data received from the sensors, keyboards, cameras, and EM readers.
